(19) United States
(12) Patent Application Publication
(10) Pub. No.: US 2015/0275682 A1
(43) Pub. Date: Oct. 1, 2015

(54) SPRAYED HAYNES 230 LAYER TO INCREASE SPALLATION LIFE OF THERMAL BARRIER COATING ON A GAS TURBINE ENGINE COMPONENT

(71) Applicant: Siemens Energy, Inc., Orlando, FL (US)

(72) Inventors: David B. Allen, Oviedo, FL (US); Anand A. Kulkarni, Charlotte, NC (US); Mrinal Munshi, Orlando, FL (US)

(73) Assignee: Siemens Energy, Inc., Orlando, FL (US)

(21) Appl. No.: 14/242,196

(22) Filed: Apr. 1, 2014

(51) Int. Cl. F01D 9/04

(52) U.S. Cl. CPC F01D 9/041; F05D 2230/31; F05D 2300/177; F05D 2240/124

(57) ABSTRACT

A technique for improving the thermal protection against oxidation for a component in a gas turbine engine, for example, blades, row 1 vanes and row 2 vanes. The technique includes spraying a thin layer of alloy 230 on a base substrate of the component at those locations on the component where thermal protection against oxidation is desired. A metal bond coat layer is then deposited on the alloy 230 layer and a thermal barrier coating is deposited on the bond coat layer. The chromium, molybdenum, iron and tungsten in alloy 230 provide superior oxidation resistance, and the addition of lanthanum in the alloy 230 helps tailor thermal expansion with the thermal barrier coating resulting in higher spallation life.

### BACKGROUND OF THE INVENTION

1. Field of the Invention

This invention relates generally to providing a layer of alloy 230 on a base substrate of a component in a gas turbine engine and, more particularly, to providing a thin layer of alloy 230 sprayed on desired areas of the base substrate of components in a gas turbine engine before a bond coat layer and thermal barrier coating is applied to the substrate so as to reduce spallation of the thermal barrier coating.

2. Discussion of the Related Art

The world's energy needs continue to rise which provides a demand for reliable, affordable, efficient and environmentally-compatible power generation. A gas turbine engine is one known machine that provides efficient power, and often has application for an electric generator in a power plant, or engines in an aircraft or a ship. A typically gas turbine engine includes a compressor section, a combustion section and a turbine section. The compressor section provides a compressed air flow to the combustion section where the air is mixed with a fuel, such as natural gas, and ignited to create a hot working gas. The working gas expands through the turbine section where it is directed across rows of blades therein by associated vanes. As the working gas passes through the turbine section, it causes the blades to rotate, which in turn causes a shaft to rotate, thereby providing mechanical work.

Gas turbine engines of this type are periodically serviced for maintenance purposes. One of the maintenance operations is to detect erosion, mechanical fatigue and cracking in various turbine parts especially components in the hot gas path of the turbine section of the engine. The hot working gas paths for the first and second rows of blades, vanes and ring segments in the turbine section is directly from the combustion section of the engine, which frequently causes erosion and other damage of the these components at various locations and triggers thermal mechanical fatigue cracking. This causes the vanes to be reshaped, thus possibly directing the working gas in a non-optimal direction and could cause catastrophic failure.

A typical hot gas path component for a gas turbine engine has a base substrate that is a cast part made from a suitable nickel or cobalt alloy to withstand the high temperature environment of the turbine engine. Typically, the base substrate alloy, such as IN738, ECY-768 and IN939, includes a low concentration of aluminum so as to allow it to be easily welded when assembled and repaired when damaged. However, other vane design concerns would prefer that the base substrate alloy having a higher concentration of aluminum. For example, a thermal barrier coating (TBC), such as a suitable ceramic, is typically deposited on the base substrate to provide increased thermal protection for the vane. For those vanes employing a low aluminum alloy base substrate, a bond coat layer having a higher concentration of aluminum, such as a metallic coating layer, is generally deposited on the base substrate to provide the aluminum to help keep the TBC from spalling off of the vane. Particularly, as the base metal in these components is heated during operation of the gas turbine engine, the aluminum in the bond coat layer is oxidized creating alumina (Al₂O₃), which causes the aluminum in the bond coat layer to be depleted. Some of that alumina is formed at the transition between the bond coat layer and the TBC, which desirably operates to hold the TBC on the vane and preventing spallation of the TBC. However, a significant portion of that alumina is drawn into the substrate alloy because it has a low concentration of aluminum, which is thus not available to prevent the TBC from spalling off, and hence the TBC is lost over time. Therefore, as described, the lower the aluminum concentration in the base substrate alloy of the vane, the better the metal is for weldability and repairability, but the lower aluminum concentration increases spallation of the TBC.

The configuration of a low aluminum concentration base substrate, bond coat layer and TBC, especially for row 1 blades and row 1 and 2 vanes, often results in heavy oxidation leading to cracking in certain areas of the vane. This mainly results from early spallation of the TBC resulting in heavy oxidation, which is a result of overheating, and which depletes the bond coat of aluminum. When the TBC spalls, the metal temperature increases even more, which leads to burning and loss of metal. Further exasperating this failure is the fact that low aluminum vanes have poor oxidation resistances. When overheating occurs, a rapid loss of metal occurs, which causes a large loss of metal where the vanes mate together. Even further exasperating the problem is that vane alloys are notorious for their tendency to rapidly deplete the bond coat of aluminum. Compared to superior coating-compatible super alloys, such as CM 247, these vane alloys will always cause spallation of the TBC over relative shorter times. With the higher firing temperatures on the newer gas turbine designs, spallation could be seen on a CM247 alloy as well.

Known methods to address this problem include increasing the cooling air flow, which would decrease the metal temperature, but would also adversely impact engine power and efficiency in addition to increasing NOx emissions from the engine. Further, the vanes could be manufactured from a higher oxidation resistant alloy. However, this alternative has the drawback of increased cost, decreased castability and a decrease in weldability.

### SUMMARY OF THE INVENTION

The present disclosure describes a technique for improving the thermal protection against oxidation for a component in a gas turbine engine, for example, blades, row 1 vanes and row 2 vanes. The technique includes spraying a thin layer of alloy 230 on a base substrate of the component at those locations on the component where thermal protection against oxidation is desired. A metal bond coat layer is then deposited on the alloy 230 layer and a thermal barrier coating is deposited on the bond coat layer. The chromium, molybdenum, iron and tungsten in alloy 230 provide superior oxidation resistance, and the addition of lanthanum in the alloy 230 helps tailor thermal expansion with the thermal barrier coating resulting in higher spallation life.

Additional features of the present invention will become apparent from the following description and appended claims, taken in conjunction with the accompanying drawings.

### BRIEF DESCRIPTION OF THE DRAWINGS

FIG. 1 is a cut-away, isometric view of a gas turbine engine;

FIG. 2 is a cut-away, isometric view of a portion of a vane assembly in a gas turbine engine; and

FIG. 3 is a profile of layers deposited on a gas turbine engine component including an alloy 230 layer.

### DETAILED DESCRIPTION OF THE EMBODIMENTS

The following discussion of the embodiments of the invention directed to a technique for providing better thermal protection of a component in a gas turbine engine is merely exemplary in nature and is in no way intended to limit the invention or its applications or uses. For example, the technique described herein has particular application for blades and vanes in the engine. However, as will be appreciated by those skilled in the art, the technique may have application for other high temperature components in the engine.

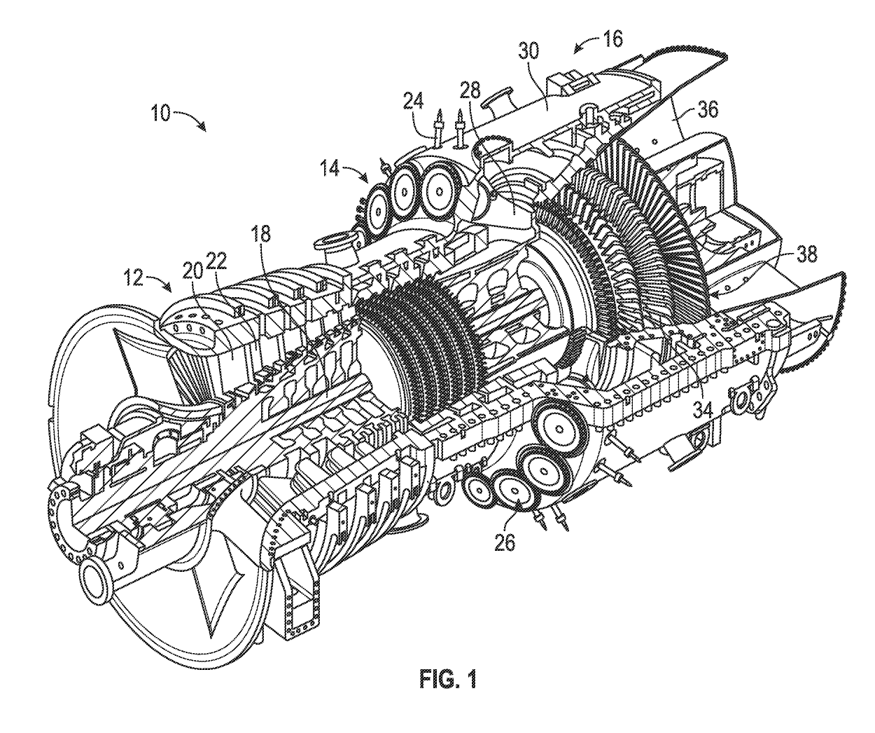

FIG. 1 is a cut-away, isometric view of a gas turbine engine 10 including a compressor section 12, a combustion section 14 and a turbine section 16 all enclosed within an outer housing 30, where operation of the engine 10 causes a central shaft or rotor 18 to rotate, thus creating mechanical work. The engine 10 is illustrated and described by way of a non-limiting example to give context to the discussion of the invention below. Those skilled in the art will appreciate that other gas turbine engine designs will also benefit from the invention. Rotation of the rotor 18 draws air into the compressor section 12 where it is directed by vanes 22 and compressed by rotating blades 20 to be delivered to the combustion section 14 where the compressed air is mixed with a fuel, such as natural gas, and where the fuel/air mixture is ignited by an igniter 24 to create a hot working gas. More specifically, the combustion section 14 includes a number of circumferentially disposed combustion chambers 26 each receiving the fuel that is sprayed into the chamber 26 by an injector (not shown) and mixed with the compressed air to be combusted to create the working gas, which is directed by a transition 28 into the turbine section 16. The working gas is directed by circumferentially disposed stationary vanes (not shown) in the turbine section 16 to flow across circumferentially disposed rotatable turbine blades 34, which causes the turbine blades 34 to rotate, thus rotating the rotor 18. Once the working gas passes through the turbine section 16 it is output from the engine 10 as an exhaust gas through an output nozzle 36.

Each group of the circumferentially disposed stationary vanes defines a row of the vanes and each group of the circumferentially disposed blades 34 defines a row 38 of the blades 34. In this non-limiting embodiment, the turbine section 16 includes four rows 38 of the rotating blades 34 and four rows of the stationary vanes in an alternating sequence. In other gas turbine engine designs, the turbine section 16 may include more or less rows of the turbine blades 34, It is noted that the most forward row of the turbine blades 34, referred to as the row 1blades, and the vanes, referred to as the row 1 vanes, receive the highest temperature of the working gas, where the temperature of the working gas decreases as it flows through the turbine section 16.

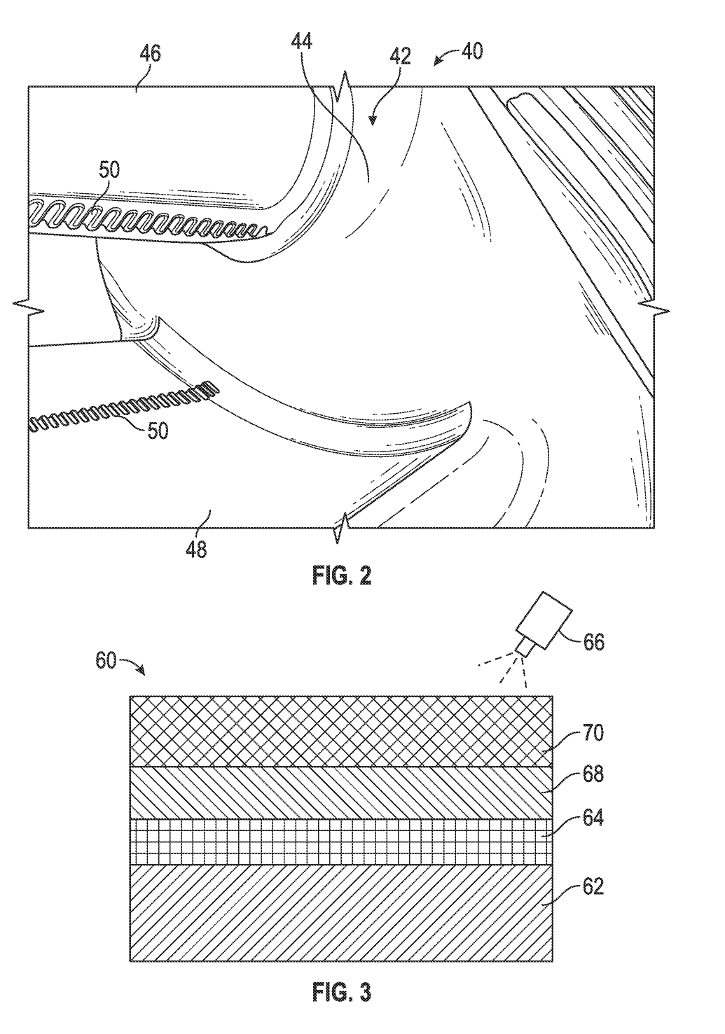

FIG. 2 is a cut-away, isometric view of a portion of a vane assembly 40 for a gas turbine engine. It is noted that the vane assembly 40 shown here is intended as a general representation of a row 1 or row 2 vane assembly for a number of styles of gas turbine engines and may or may not be the specific style suitable for the gas turbine engine 10. The vane assembly 40 includes an inner shroud 42 that extends completely around the circumference of the turbine section of the gas turbine engine, where the shroud 42 includes a suction side 44 and a pressure side opposite thereto. A plurality of spaced apart vane air foils are attached to and extend from the suction side 44 of the inner shroud 42 and receive the hot working gas in the turbine section of the gas turbine engine to direct the gas onto a row of blades. In the illustration of FIG. 2, two of the air foils 46 and 48 are shown, where it will be understood by those skilled in the art that several air foils for the particular design extend from the shroud 42 around a circumference of the turbine section of the engine. The vane assembly 40 also includes an outer shroud not shown) opposite to the inner shroud 42 and also coupled to the air foils 46 and 48 in the same manner as the inner shroud 42, and also including a suction side and a pressure side, as would also be well understood by those skilled in the art.

In this specific design, cooling holes 50 are provided in the air foils 46 and 48 and provide air cooling for those components. However, in this design, generally for increased power and performance requirements, there are no cooling holes provided in the inner shroud 42. Because the suction side 44 of the inner shroud 42 and the suction side of the outer shroud are subjected to very hot temperatures, and for those designs that employ a base substrate alloy that is low in aluminum, such as IN939, significant oxidation occurs at this area in the assembly 40 requiring significant repair, such as welding on replacement pieces, at periodic intervals, which is very costly.

The present invention proposes providing an oxidation resistant layer in addition to the known layers on the vane assembly 40, and other hot gas components, at the necessary and/or desired locations that is compatible with the known base alloy, bond coat layer and TBC layer. Particularly, the new layer is an alloy 230 layer, such as Haynes™ 230 alloy, deposited directly on the base substrate and before the bond coat layer. Alloy 230 is a known oxidation resistant material and has a chemical composition of 57 weight percent Ni, 22 weight percent Cr, 14 weight percent W, 2 weight percent Mo, 3 weight percent Fe, 5 weight percent Co, 0.5 weight percent Mn, 0.4 weight percent Si, 0.3 weight percent Al, 0.1 weight percent C, 0.02 weight percent La, and 0.015 weight percent B. The chromium, molybdenum, iron and tungsten in alloy 230 provide superior oxidation resistance, and the addition of lanthanum in the alloy 230 helps tailor thermal expansion with the thermal barrier coating resulting in higher spallation life.

It is noted that the discussion above refers to providing an alloy 230 layer at certain locations on the vane assembly 40 where greater thermal protection is desired. However, the alloy 230 layer can be applied to the entire vane assembly 40, including the airfoils 46 and 48, if thermal protection of those areas is desired. Further, the alloy 230 layer can be applied to other hot gas components including the blades 34 of the gas turbine engine 10, including the entire component, only certain blade portions or certain blade rows as necessary or desired.

FIG. 3 is an illustration of a profile 60 showing the component layers referred to above, where the profile 60 is intended to represent any or all of a vane shroud, a vane airfoil, a blade, etc. Particularly, the profile 60 includes a substrate 62 comprised of the base metal, typically IN939, which is low in aluminum, but has good weldability and castability, as discussed above. An alloy 230 layer 64 is deposited directly on the substrate 62 to a desired thickness to provide the oxidation protection, as discussed herein. In one non-limiting embodiment, the alloy 230 layer 64 is sprayed on the substrate 62 using, for example, a spraying system 66, that may employ any suitable technique available and known in the art, such as thermal spraying using a high velocity oxy fuel (HVOF). In one non-limiting example, the alloy layer 64 is sprayed on the substrate 62 to a thickness in the range of 0.005 to 0.010 inches. As mentioned, the alloy 230 layer can be sprayed on the substrate 62 only at those locations where the oxidation protection is necessary, such as the suction side 44 of the inner shroud 42 and the suction side of the outer shroud. A bond coat layer 68 is then deposited on the alloy 230 layer 64 by known techniques, such as by spraying possibly also using the spraying system 66, where the bond coat layer 68 is a metal layer of the type discussed above that provides the desired aluminum content. In one non-limiting example, the bond coat layer 66 is deposited on the alloy layer 64 to a thickness in the range of 0.005 to 0.010 inches. A TBC layer 70 of a known type is then deposited on the bond coat layer 68, such as by spraying, possibly also using the spraying system 66, to provide the thermal barrier for the reasons discussed above. In one non-limiting example, the TBC layer 70 is deposited on the bond coat layer 68 to a thickness in the range of 0.008 to 0.020 inches. Although the alloy 230 layer 66 may be provided at those areas on the component where oxidation damage occurs, the bond coat layer 68 and the TBC layer 70 are likely provided at all locations on the component.

The foregoing discussion discloses and describes merely exemplary embodiments of the present invention. One skilled in the art will readily recognize from such discussion, and from the accompanying drawings and claims, that various changes, modifications and variations can be made therein without departing from the scope of the invention as defined in the following claims.

What is claimed is:

1. A component for a gas turbine engine, said component comprising a substrate, an alloy 230 layer deposited on the substrate, a bond coat layer deposited on the alloy 230 layer and a thermal barrier coating (TBC) layer deposited on the bond coat layer.

2. The component according to claim 1 wherein the alloy 230 layer is only deposited on the component at predetermined high oxidation locations.

3. The component according to claim 2 wherein the component is a vane assembly, said vane assembly including an inner shroud, an outer shroud and a plurality of vane air foils coupled to the inner shroud and the outer shroud, wherein one of the predetermined locations is a suction side of the inner shroud between the air foils.

4. The component according to claim 3 wherein another predetermined location is a suction side of the outer shroud between the air foils.

5. The component according to claim 1 wherein the substrate is comprised of IN939.

6. The component according to claim 1 wherein the alloy 230 layer is deposited on all locations of the component.

7. The component according to claim 1 wherein the component is a hot working gas component.

8. The component according to claim 7 wherein the component is a blade or a vane assembly in the gas turbine engine.

9. The component according to claim 8 wherein the vane assembly is a row 1 vane assembly or a row 2 vane assembly.

10. The component according to claim 1 wherein the alloy 230 layer has a thickness in the range of 0.001 to 0.050 inches.

11. The component according to claim 1 wherein the alloy 230 layer is sprayed on the substrate.

12. The component according to claim 11 wherein the alloy 230 layer is sprayed on the substrate by thermal spraying using a high velocity oxy fuel (HVOF).

13. A vane assembly for a gas turbine engine, said vane assembly comprising an inner shroud, an outer shroud and a plurality of vane air foils coupled to the inner shroud and the outer shroud, wherein one or more of the air foils, the inner shroud and the outer shroud include a vane substrate, an alloy 230 layer deposited on the substrate, a bond coat layer deposited on the alloy 230 layer and a thermal barrier coating (TBC) layer deposited on the bond coat layer.

14. The vane assembly according to claim 13 wherein the alloy 230 layer is only deposited on the inner and outer shroud at predetermined high oxidation locations.

15. The vane assembly according to claim 14 wherein one of the predetermined locations is a suction side of the inner shroud between the air foils.

16. The vane assembly according to claim 14 wherein another predetermined location is a suction side of the outer shroud between the air foils.

17. The vane assembly according to claim 13 wherein the alloy 230 layer is deposited on the air foils.

18. The vane assembly according to claim 13 wherein the alloy 230 layer has a thickness in the range of 0.001 to 0.050 inches.

19. A gas turbine engine comprising:
a shaft rotatably provided along a center line of the engine;
a compressor section responsive to a working fluid and being operable to compress the working fluid to produce a compressed working fluid;
a combustion section in fluid communication with the compressor section that receives the compressed working fluid, said combustion section mixing the compressed working fluid with a fuel and combusting the compressed fluid and fuel mixture to produce a hot working fluid; and
a turbine section in fluid communication with the combustion section, said turbine section expanding the hot working fluid to produce mechanical power through rotation of the shaft, said turbine section including hot gas components, wherein one or more of the hot gas components include a substrate, an alloy 230layer deposited on the substrate, a bond coat layer deposited on the alloy 230 layer and a thermal barrier coating (TBC) layer deposited on the bond coat layer.

20. The gas turbine engine according to claim 19 wherein the hot gas components include row 1 blades, row 1 vanes and row 2 vanes.
